(19) United States
(12) Patent Application Publication
(10) Pub. No.: US 2002/0051577 A1
(43) Pub. Date: May 2, 2002

(54) Method of preventing falsification of image

(76) Inventor: Naoto Kinjo, Kanagawa (JP)

Correspondence Address: BIRCH STEWART KOLASCH & BIRCH, PO BOX 747, FALLS CHURCH, VA, 22040-0747, US

(21) Appl. No.: 09/981,920

(22) Filed: Oct. 19, 2001

(30) Foreign Application Priority Data
Oct. 20, 2000 (JP) 2000-320229

(51) Int. Cl. G06K 9/68

(52) U.S. Cl. 382/218

(57) ABSTRACT

This invention relates to a method of preventing falsification of an image of a produced image produced in an imaging apparatus, comprising the steps of: extracting a first image characteristic amount by a specified algorithm from the produced image in the imaging apparatus, recording identification information of the produced image in the imaging apparatus and the image characteristic amount into a database of an authentication section which authenticates a status that there is no falsification in the produced image; regarding as an authentication object image whose authentication is requested to the authentication section, extracting a second image characteristic amount by the specified algorithm from said authentication object image; comparing the first image characteristic amount with the second image characteristic amount in which the first image and the second image has the same identification information; and judging whether or not the authentication object image is falsified after the image production, based on consistency between the first and second image characteristic amounts acquired from the comparison in order to prevent the falsification of the produced image based on the judgment.

### BACKGROUND OF THE INVENTION

The present invention relates to a method of preventing falsification of a produced image which is produced using an imaging apparatus such as a photographic image photographed using a digital still camera etc. or an image-processed image which is image-processed using a computer etc., which prevents digital image data from being falsified by authenticating a status that there is no falsification in the digital image data.

The exposure systems in photography technologies using silver halide have performed printing through analog exposure such as plane exposure and direct exposure in general. Specifically, the exposure has been performed in such a manner that a developed negative film is disposed at a predetermined printing position, light from a white light source such as halogen lamp is irradiated thereon, and then a transmitted image from the negative film is formed on a photographic paper.

Contrary thereto, a printing apparatus using digital exposure, i.e., a digital photo printer has been recently put into practical use. In this digital photo printer, a pieces of image recorded on photographic films such as a negative film and a color reversal film are read out photoelectrically, and the read out image is converted into digital signals. Thereafter, image data for recording is acquired through various kinds of digital image processing, and then a photosensitive material is subjected to scanning exposure using recording light modulated according to the image data. Subsequently, the image (latent image) is recorded, thus completing a (finished) print.

Such a digital photo printer regards the images as digital image data. Therefore, this digital photo printer is capable of processing not only an image in the photographic film but also an image photographed by a digital still camera and image data recorded as digital data in various storage mediums such as a magnetic storage medium, which is a CD-R; a flexible disc and a removal hard disc such as Zip and Jaz; and an optomagnetic storage medium such as an MO disc, and outputting them as a print.

Such digital data has advantages that connection and transmission of data to an information processing/information-communication equipment such as a personal computer are easy. However, the digital data has disadvantages that the data can be relatively falsified freely because of easy data handling. Therefore, it has been difficult to prevent data falsification and to authenticate data validity.

For example, there occurs damage claim management of automobile insurance or the like owing to a traffic accident or the like. When a photographic image photographed by a digital camera is used as a photographic evidence for damage assessment, it has become a matter of concern how to see through and prevent dishonesty by falsification of the photographic image or replacement with a fake photographic image (counterfeiting of a photograph).

One proposal for overcoming the foregoing problem has been disclosed in the technical report of the Section of Electronics, Information and Communication Engineers. It is the technical report titled “Function of Preventing and Detecting Falsification of Digital Photograph in Insurance claim Management Group Work System” by Kazuharu TOYOKAWA, Norishige MORIMOTO, Satoko TONEGAWA, Kouichi KAMIJO, and Akio KOIDE, pp.1 to pp.8, IE 99 to 38, published in September, 1999. According to this report, when an adjuster photographs a damaged car using the digital camera mounting a memory card with a specified (particular) identification (hereinafter called as “ID”) information and a certification key embedded therein, the digital camera automatically writes a photographed date and an authentication mark into a memory card. When the memory card is read out using a device driver of a computer for reading out the memory card, presence of the authentication mark guarantees a fact that the photograph is both an authentic photograph and not a modified photograph.

In addition to the conventional delivery of the image data using the storage medium such as the memory card, data transmission through communication lines is also carried out. In this case, there may be possibility that the data is illegally falsified or replaced with fake data by a third person or a third party. Therefore, security protection in communication has become a matter of concern.

In order to overcome the foregoing problem, various methods of preventing data replacement on purpose and falsification have been heretofore examined, such as a method of encrypting and transmitting information that guarantees validity of the data, a method employed for an electronic signature and a method employed for an electronic watermark, in which invisible information is embedded into the image.

However, data is transmitted from the camera via the memory card using a predetermined protocol in the proposal disclosed in the above-mentioned gazette. Therefore, a memory card having a specific hardware authentication function is required, and this is not thus suitable when it is to be used by unspecified number of users. Accordingly, realization of a system has been desired, such as being capable of authenticating a status that an image is not falsified, without requiring any storage medium having a special function as above-mentioned.

Further, as above-mentioned, various methods employed for security protection of communication of data have been developed such as data encrypting and electronic watermark. However, any truly effective method of preventing the image data falsification has not been realized yet.

### SUMMARY OF THE INVENTION

The present invention had been completed by the inventor as a result that he eagerly researched a truly effective method of preventing falsification of an image in order to realize a system for authenticating a status that there is no falsification without any recording medium having specified functions such as above mentioned conventional arts.

Namely, in order to overcome the above-mentioned problems, the first aspect of the present invention provides a method of preventing falsification of an image of a produced image produced in an imaging apparatus, comprising the steps of:

extracting a first image characteristic amount by a specified algorithm from the produced image in the imaging apparatus;

recording identification information of the produced image in the imaging apparatus and the first image characteristic amount into a database of an authentication section which authenticates a status that there is no falsification in the produced image;

regarding as an authentication object image whose authentication is requested to the authentication section,

extracting a second image characteristic amount by the specified algorithm from the authentication object image;

comparing the first image characteristic amount with the second image characteristic amount, in which the extracted authentication data and the authentication data recorded in the database have the same identification information,; and

judging whether or not the authentication object image is falsified after the image production, based on consistency between the first and second image characteristic amounts acquired from the comparison in order to prevent the falsification of the produced image based on the judgment.

Further, in order to overcome the above-mentioned problems, the second aspect of the present invention provides a method of preventing falsification of a produced image produced in an imaging apparatus, comprising the steps of:

producing an image to acquire a first image data of the produced image in the imaging apparatus,

recording identification information for identifying the produced image by the imaging apparatus and said first image data of the produced image by the imaging apparatus into a database in an authentication section which authenticates that there is no falsification in the produced image,

comparing a second image data of authentication object image which has been requested to be authenticated by the authentication section, with the first image data recorded in the database, in the authentication section, in which the extracted authentication data and the authentication data recorded in the database have the same identification information, and

judging whether or not the authentication object image is falsified after the image production, based on consistency between the first and second image characteristic amounts acquired from the comparison in order to prevent the falsification of the produced image based on the judgment.

Furthermore, in order to overcome the above-mentioned problems, the third aspect of the present invention provides a method of preventing falsification of a produced image produced in an imaging apparatus, comprising the steps of:

sending authentication data from an authentication section for authenticating a status that there is no falsification in a produced image which is produced by the imaging apparatus to the imaging apparatus,

recording the authentication data and identification information for identifying said produced image of the imaging apparatus into a database in the authentication section,

attaching the authentication data to the produced image or embedding said authentication data into the produced image, when the imaging apparatus produces the produced image,

extracting said authentication data from an authentication object image which has been requested to be authenticated in the authentication section,

comparing the extracted authentication data with the authentication data recorded in the database, in which the extracted authentication data and the authentication data recorded in said database have the same identification information, and

judging whether or not the authentication object image is falsified after the image production, based on consistency between the extracted authentication data and the authentication data acquired from the comparison in order to prevent the falsification of the produced image based on the judgment.

In each of the above-mentioned embodiments, it is preferable that the imaging apparatus has a camera, in which the produced image is a photographic image photographed by the camera, in which the identification information is an identification information of the camera or a file name of the photographic image or an identification information of a photographer of the photographic image.

Additionally, in each of the above-mentioned embodiments, it is preferable that the imaging apparatus has a computer in which the produced image is a computer graphics image produced by the computer or an image which has been image-processed by the computer in which the identification information is an identification information of the computer or a file name of the produced image or an identification information of a producer of the produced image. Optionally, wording of “recoding data etc. into a database” is equal to that of “registering data etc. into a database”.

### BRIEF DESCRIPTION OF THE DRAWINGS

FIG. 1 is a block diagram schematically showing an embodiment of a system for implementing a method of preventing falsification of photographed image according to a first embodiment of the present invention.

FIG. 2 is a flow chart showing an example of a method of photographing using a camera in the first embodiment.

FIG. 3 is a flow chart showing an example of a method employed for authentication process also in the first embodiment.

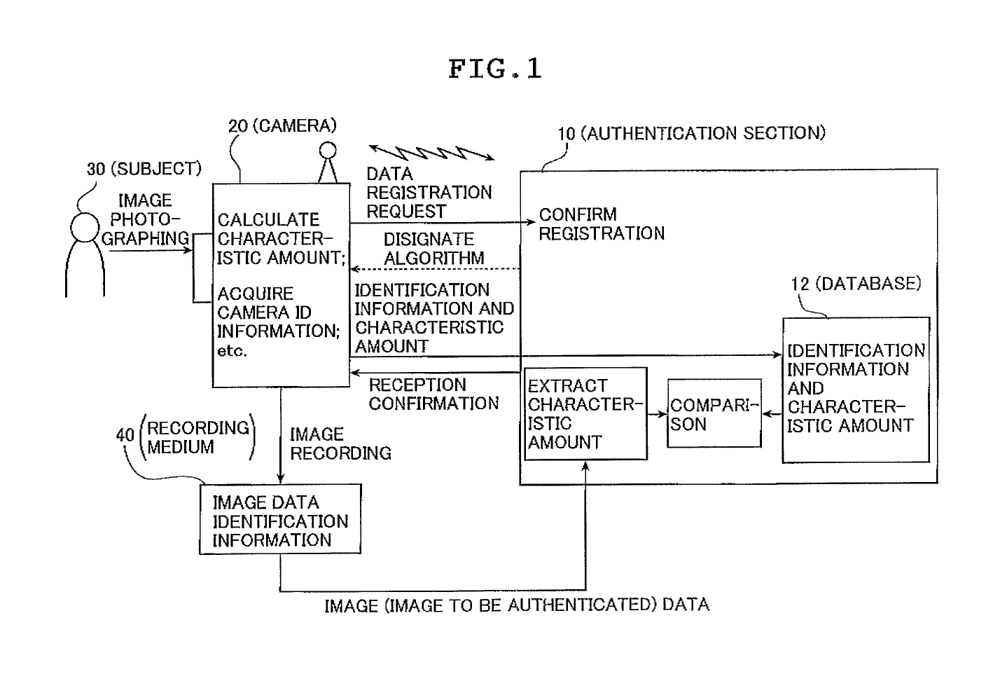

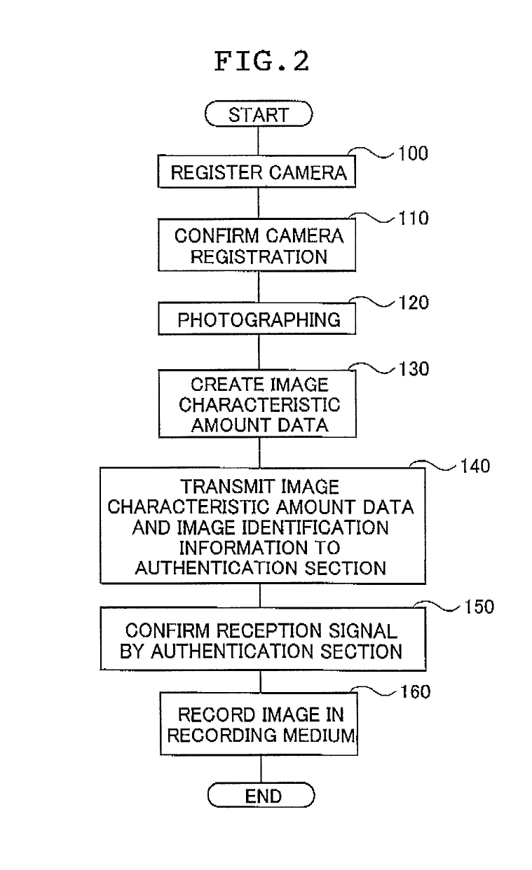

FIG. 1 is a block diagram schematically showing an embodiment of a system for implementing a method of preventing falsification of photographed image according to a first embodiment of the present invention.

FIG. 2 is a flow chart showing an example of a method of photographing using a camera in the first embodiment.

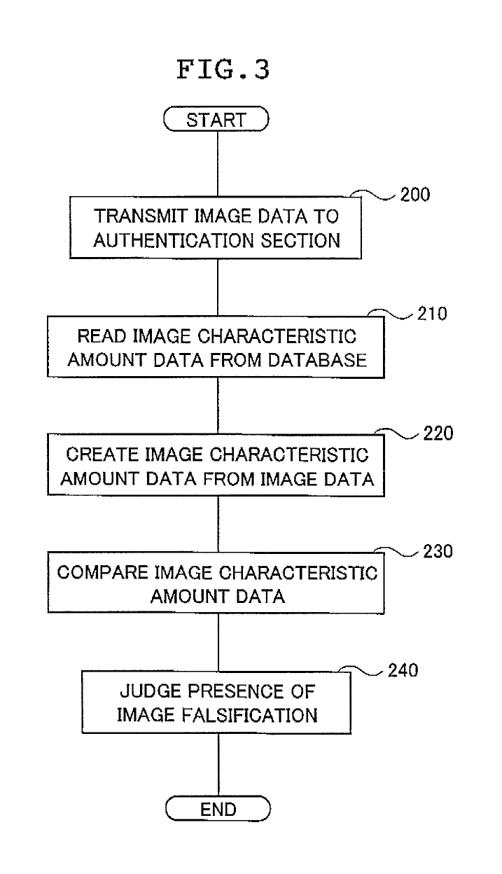

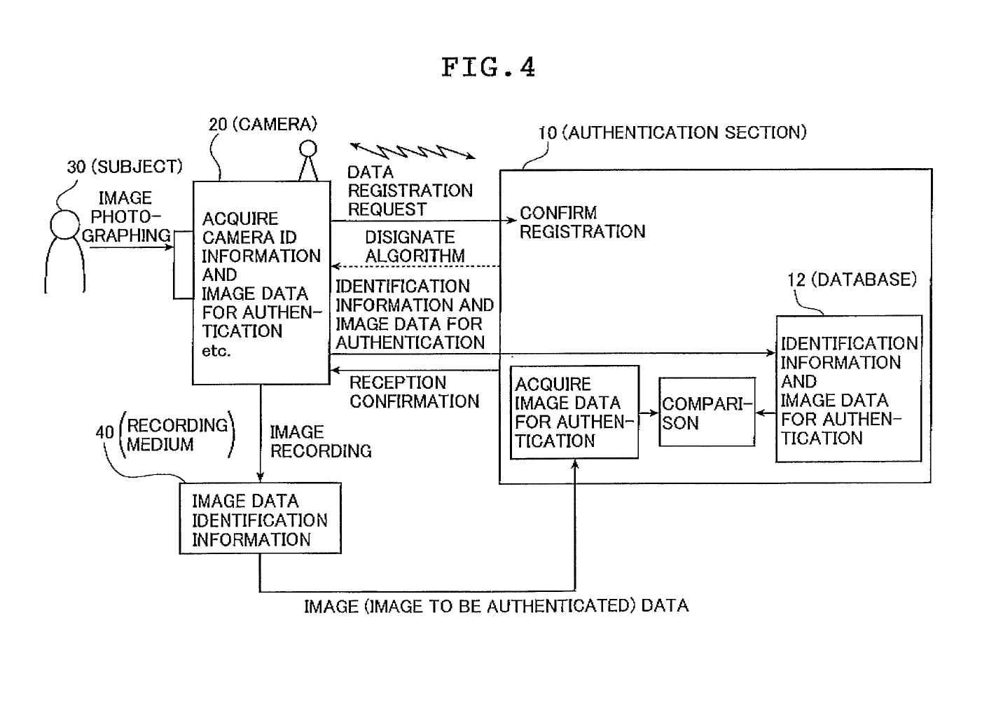

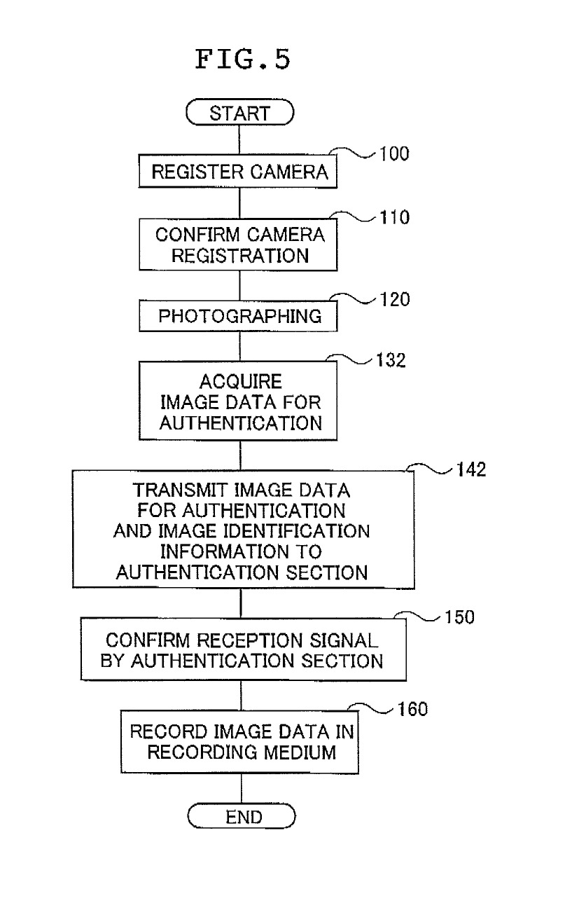

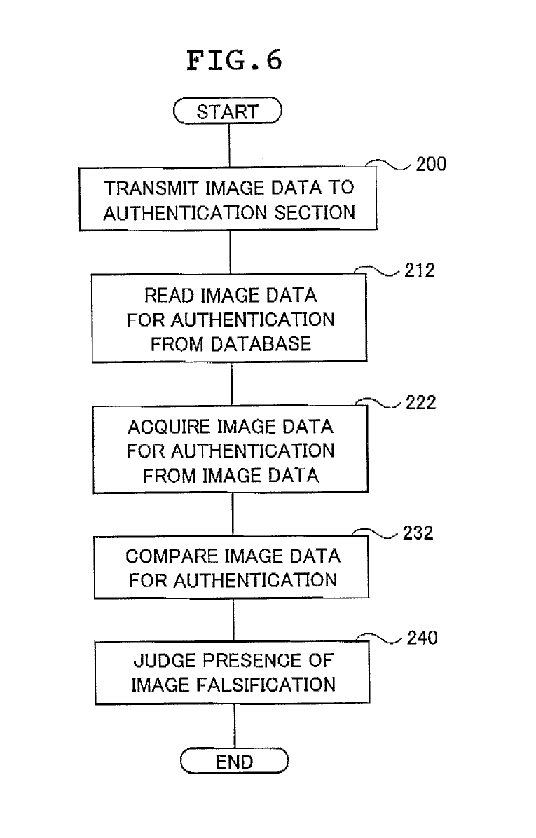

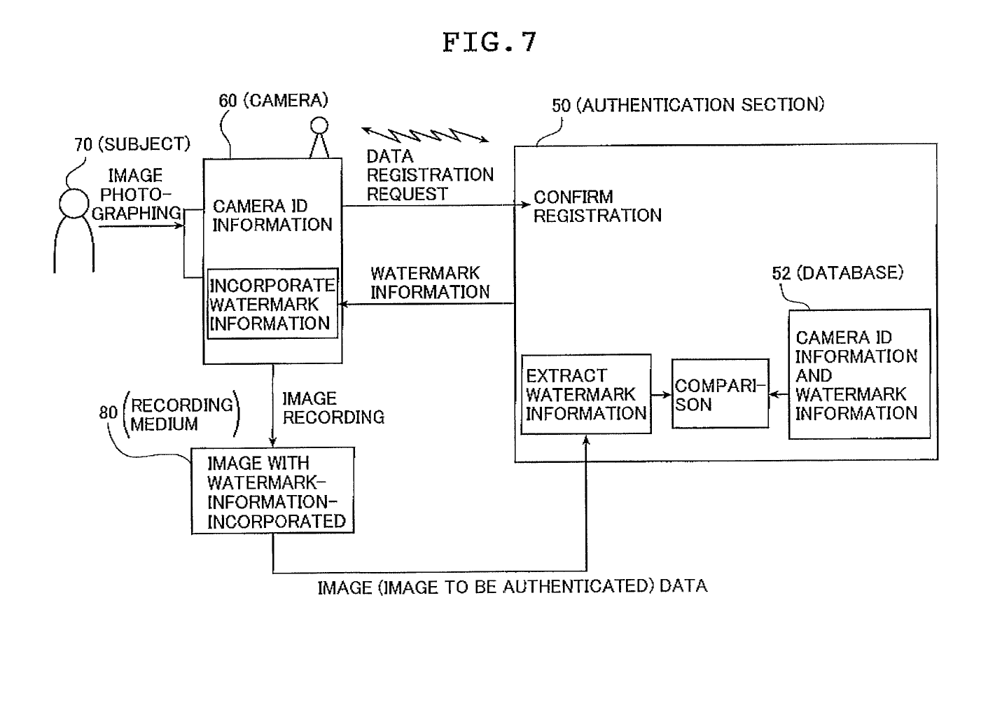

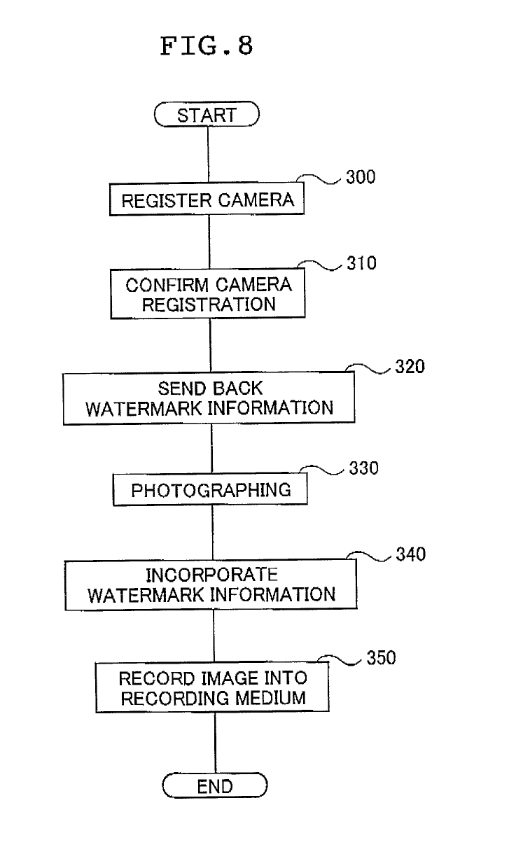

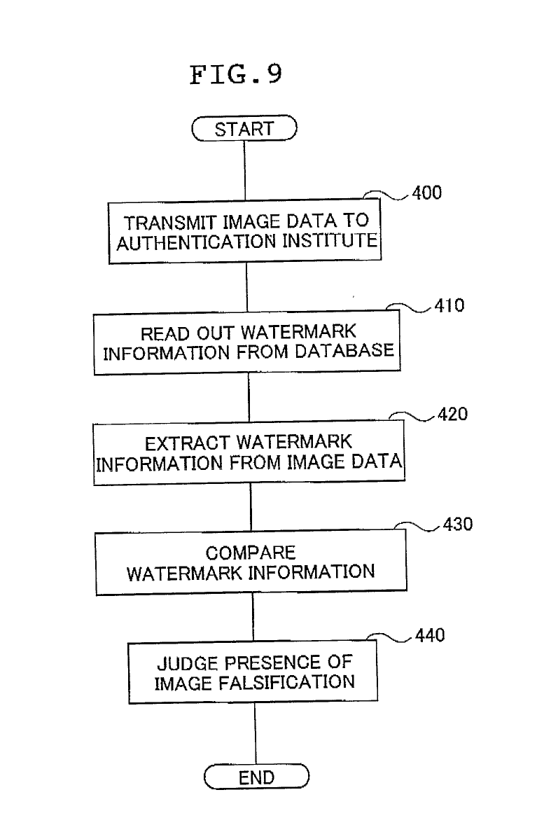

FIG. 3 is a flow chart showing an example of a method employed for authentication process also in the first embodiment.

FIG. 4 is a block diagram schematically showing an embodiment of a system for implementing a method of preventing falsification of photographed image according to a second embodiment of the present invention.

FIG. 5 is a flow chart showing an example of a method of photographing using a camera in the second embodiment.

FIG. 6 is a flow chart showing an example of a method employed for authentication process also in the second embodiment.

FIG. 7 is a block diagram schematically showing an embodiment of a system for implementing a method of preventing falsification of photographed image according to a third embodiment of the present invention.

FIG. 8 is a flow chart showing an example of a method of photographing using a camera in the third embodiment.

FIG. 9 is a flow chart showing an example of a method employed for authentication process also in third first embodiment.

### DESCRIPTION OF THE PREFERRED EMBODIMENTS

Methods of preventing falsification of an image according to the present invention based on preferred embodiments shown in the accompanied drawings, will be described as follows. Optionally, in turn, the methods can be used also for authenticating an image.

The present invention is directed to a method of preventing falsification of digital image data which is a photographic image which has been photographed using a digital still camera or the like, an image having been image-processed using a computer, etc. or an image having been produced using a computer or the like. Followings will be explained that each of a camera and a photographic image is representative of an imaging apparatus and a produced image which has been photographed using the imaging apparatus, respectively. However, needless to say, the preset invention is not limited within following scope areas.

Initially, a first embodiment of the present invention is described. In this embodiment, predetermined image characteristic amount data extracted from a photographed image in an image capturing device such as a camera is sent to an authentication section, and this authentication section authenticates the image using the image characteristic amount data. Hereinafter, the image capturing device is hereinafter regarded as “a camera” in this specification.

FIG. 1 is a block diagram schematically showing an embodiment of a system for implementing the method of preventing falsification of a photographed image according to the first embodiment.

In FIG. 1, an authentication section 10 functions to authenticate a status that a photographed image is photographed by a proper camera 20 registered in the authentication section 10 and a status that the image is an authentic image which was not falsified after being photographed. The camera 20 is registered in the authentication section 10 in advance. When photographing a subject 30, the camera 20 communicates with the authentication section 10 and sends information necessary for authenticating the photographed image to the section 10. Then, the camera 20 receives confirmation of registration from the authentication section 10, and then stores the photographed image in a storage medium 40 such as a smart media.

Further, the authentication section 10 has a database 12 for recording information necessary for authenticating the photographed image, such as identification information of the photographed image and the image characteristic amount, which are sent from the camera 20 to the section 10.

An example of a photographing method using a camera and an example of an authentication method of authenticating an image are shown in the flow charts of FIGS. 2 and 3 respectively. Operation of this embodiment will be described along with these flow charts.

Note that, in this embodiment, the data is all encrypted and then transmitted in order to prevent a third person or party from transmitting a counterfeit image, while pretending to be a camera 20 registered in the authentication section 10.

At first, description will be made for the photographing method of using the camera along with the flow chart shown in FIG. 2. At step 100, the camera 20 is registered in the authentication section 10 in advance. A unique ID information and key data for encrypting are beforehand assigned to the camera 20 upon shipping or selling of the camera 20. The ID uniquely identified to the camera is registered in the authentication section 10. Therefore, registration of the camera is required only once at the beginning.

Then, when photographing an image using the camera 20, first at step 110, the authentication section 10 confirms/authenticates a status that the camera to be used for photographing is the one registered in the authentication section 10. For this purpose, the camera 20 sends a data registration request signal (information necessary for confirming a status that the camera has been registered in the authentication section 10) to the authentication section 10. Specifically, the camera 20 encrypts the camera ID information or the like and sends it to the authentication section 10. Upon receiving the encrypted data registration request signal from the camera 20, the authentication section 10 decrypts the signal to confirm a status that the camera 20 has already been registered.

The method of confirming registration of the camera using the encryption is not particularly limited, and any well known encrypting technology can be adopted. For example, an example of an authentication method of using the encryption is disclosed in the Interface Magazine of February 2000, pp.148 to pp.149.

Once the authentication section 10 confirms a status that the camera 20 has already been registered in the authentication section 10, the camera 20 photographs the subject 30 at the following step 120.

After photographing, at step 130, the camera 20 creates image characteristic amount data from the photographed image data using a specified algorithm for the authentication section 10 to use when authenticating validity of the image later on.

Further, a specific algorithm used in creating the image characteristic amount data is not particularly limited. For example, an algorithm can be mentioned, in which an image is divided into some areas (blocks), each having a predetermined size, and edges and spatial frequencies or a histogram of each block are calculated. This algorithm may take in a hardware as a characteristic amount data preparing unit and embedded into the camera 20 after being combined with a photographing device to form a single chip. Thereby, it is able to prevent a counterfeit image from interrupting during the communication.

In addition, this algorithm should be desirably confidential, Further, on the assumption that there may be a case where the algorithm could be decrypted, a plurality of kinds of the algorithm may be prepared, and one of them may be selected randomly using the camera 20 in each photographing session. Alternatively, the algorithm may be selected according to an instruction signal from the authentication section 10.

When the camera 20 selects the algorithm, selection information showing the selection result of the algorithm is to be added to the image characteristic amount data and sent to the authentication section 10. Further, when the algorithm is selected according to the instruction signal from the authentication section 10, the authentication section 10 is set so as not to receive the signal from the camera 20 during a specified period of time after sending the instruction signal to the camera 20. Thereby, it becomes possible to prevent an interruptive transmission of the already created counterfeit image even if the user of the camera 20 bears harmful intention.

Next, at step 140, the camera 20 encrypts the image characteristic amount data just created and a piece of photographed image (data) ID information, respectively to send them as a set to the authentication section 10. In this case, the photographed image (data) ID information includes at least of a file name, a camera ID information and ID information of a photographer and the like. After the camera is authenticated, the data is transmitted using a common key (secret key) system because the common key system requires less computing. For example, secret key data unique to each camera is transmitted using a public key system at first, and the secret key data is used for encrypting the image characteristic amount data. Alternatively, other well known encrypting method is used.

Also, as above-mentioned, when the camera 20 selects an algorithm for creating the image characteristic amount data, an algorithm selection information is added to the image characteristic amount data and sent to the authentication section 10.

The authentication section 10 stores (records) the received image characteristic amount data and the photographed image identification information in the database 12. Then, a kind of the algorithm employed in creating the image characteristic amount data is also stored.

At step 150, when the authentication section 10 decrypts the above-mentioned received signal and confirms a status that the data is from the authenticated camera, the authentication section 10 returns a reception confirmation signal to the camera 20. Next, at step 160, when the camera 20 receives the confirmation signal, the camera 20 stores the photographed image in the storage (recording) medium 40. Here, the photographed image identification information is embedded into the photographed image as a header.

Photographing process by using the camera 20 is carried out as above-mentioned. A recipient of the storage medium 40 with the image thus photographed recorded therein sends the recorded image data and further the image identification information to the authentication section 10 using a predetermined communication method and requests authentication of validity of the image.

Following will be described for the authentication process, referring to the flow chart shown in FIG. 3.

When the recipient of the photographed image requests falsification check of the image to the authentication section 10, first at step 200, the image data is transmitted to the authentication section 10.

Next, at step 210, the authentication section 10, which has received the image data, reads out the image characteristic amount data corresponding to the previously-stored image from the database 12, using the photographed image identification information provided to the header of the image data.

At step 220, the authentication section 10 creates image characteristic amount data from the image to be checked (image to be authenticated) using the same algorithm as the image characteristic amount data creating algorithm employed by the camera 20 during previous photographing. As above-mentioned, a kind of the algorithm employed when a photographed image is further recorded in the database 12. Therefore, it is possible to use the same algorithm by reading out this kind of the algorithm from the database 12.

Subsequently, at step 230, the image characteristic amount data created from the image to be checked is compared with the image characteristic amount data read out from the database 12.

Then, consistency between both of data is calculated. If the consistency is equal to a predetermined value or greater, at step 240, it is judged that the image to be checked is not falsified after being photographed. Here, the exact matching between the data is not required and the consistency equal to a predetermined value or larger is regarded to be sufficient. This is because there is a possibility that information deteriorates due to compression process such as JPEG when stored using a camera, and the image to be checked is not thus necessarily completely consistent with the original image.

As above-mentioned, according to this embodiment, it becomes possible to effectively cope with the case where a counterfeit image is disguised as the image photographed by the authenticated camera and to effectively prevent the photographed image from being falsified.

The above-mentioned first embodiment of the present invention is characterized that first, predetermined image characteristic amount data extracted from a photographic image are sent from a camera to an authentication section and secondly, the authentication section authenticates an image using the image characteristic amount data. However, the present invention is not limited thereto. Namely, like following second embodiment of the present invention, image data of a photographic image as it stands, the corresponding compressed image data or the corresponding thinned-out image data instead of the image characteristic amount data can be used as image data for authentication.

FIG. 4 shows a schematic block diagram of one embodiment of a system which carries out a method of preventing falsification of a photographic image relating to the second embodiment. FIG. 5 shows a flowchart of an example of photographing method using a camera in the second embodiment. FIG. 6 shows a flowchart of an example of a method of authenticating an image.

Optionally, the system carrying out the second embodiment shown in FIG. 4 and the flowcharts shown in FIGS. 5 and 6 are substantially as similar as the system carrying out the first embodiment shown in FIG. 1 and the flowcharts shown in FIGS. 2 and 3 except for using image data for authentication instead of the image characteristic amount data of the photographic data. Therefore, reference numerals in FIGS. 1, 2 and 3 are labeled as same as those in FIGS. 4, 5 and 6, further the explanation about these same ones is omitted as to the same constitutional elements and the same steps between the first embodiment and the second embodiment.

As shown in FIGS. 4 and 5, using a camera 20 which is registered to the authentication section 10 at step 100 and which is confirmed (authenticated) by the authentication section 10 at step 110, a subject 30 is photographed at step 120, whereby the camera 20 can acquire image data of the photographic image.

In the second embodiment, after the photographing, at step 132, image data for authentication acquired using the camera 20 used for when the authentication section 10 authenticates validity of image by the authentication case 10 is acquired from the image data of the photographic image. Here, image data of the photographic image as they stand can be regarded as the image data for authentication.

In the second invention, it is preferable in view of a point that authentication becomes more accurate to use the entire image data of the photographic image as image data for authentication. However, if the entire image data are used, the data amount becomes greater. On the other hand, it may cost more time depending on transmission and reception capability of the data communicated between the camera 20 and the authentication section 10 and data authenticating capability at the authentication section. Therefore, compressed image data or thinned-out image data in which a predetermined data is properly thinned out from the entire image data can be used as authentication image data. Likewise, the compressed data or the thinned-out data used for the authentication may be data acquired using a well-known data compression method or data thinning-out method from image data of a photographic image. However, it is preferable that the compressed data or the thinned-out data used for the authentication should be produced using a specified compressing algorithm and a specified thinning-out algorithm.

Further, the specified compressing algorithm and the specified algorithm are not especially limited, namely any algorithm, i.e. a well-known algorithm can be used. Optionally, the compressed image data of the photographic image may have only to decompress (decode) the compressed image data. The entire image data of the photographic image may not be decompressed. Therefore, the compression method or the thinned-out method may be used, which is not necessary to decompress the entire image data.

Further, an algorithm used for the specified compressing algorithm or the specified thinning-out algorithm e.g. should not desirably be in public. The algorithm therefore is selected from among a plurality of kinds of algorithm at the time of photographing at the camera 20 side. The algorithm can be selected depending on instructions signal from the authentication section 10. As above-mentioned, each of these algorithm can be used in a manner as same as the image characteristic amount extracting algorithm. Further, e.g., the specified algorithm can be formed as a hard ware called as image data acquiring section. Namely, the specified algorithm is formed in combination with a desired photographic element, as a single chip. The single chip is embedded into the camera 20. Thereby, interruption of falsification image on the way of the communication can also be prevented.

Next, at step 142, the camera 20 encrypts the presently acquired image data for authentication and the photographic image (data) identification information (which is called “identification information”) and transmits a set of them to the authentication section 10. If the camera is authenticated, then transmission and reception of data are performed in a common key (secret key) method. Further, as above-mentioned, if image data acquiring algorithm for authentication at the camera, an algorithm selection information can be attached to image data for authentication and sent the information attached to the image data for authentication to the authentication section 10.

The authentication section 10 records image data for authentication and ID information which have been received into the database 12. Then they are recoded in combination with the kind of the adopted image data producing algorithm for authentication.

Hereinafter, like the first embodiment, at step 150, the authentication section 10 decrypts the reception signal, confirms that the decrypted signal has data of the authenticated camera and return the reception confirmation signal to the camera 20.

Next, at step 160, the camera 20 receives this conformation signal and records image data of a photographic image onto the recording medium 40. Then, ID information is attached to the image data as a hedder.

A photographic processing using the camera 20 will be performed as follows. A person which has thus received the recording medium 40 in which a photographed image was recorded transmits the recorded photographic image data in the recording medium 40 with ID information to the authentication section 10 by way of a predetermined communication unit to request authentication of the validity of the image.

The authentication processing will be explained using a flowchart in FIG. 6.

When a person which has received a photographed image requests image-falsification-checking to the authentication section 10, like the first embodiment, at first, at step 200, the image data of the photographic image is transmitted to the authentication section 10.

At next, at step 211, the authentication section 10 which has received the image data of the photographic image, reads out image data for authentication corresponding to the photographic image before-recorded from the database 12, using ID information attached to a header of the image data of the photographic image.

Further at step 222, the authentication section 10 reads out an algorithm as same as the image data acquiring algorithm for authentication before-adopted at the time of photographing in the camera 20 and acquires image data for authentication from an image to be checked (authentication object image) using the read-out algorithm. Optionally, as above-mentioned, the image data for authentication may be the image data of the authentication as it stands.

Next, at step 232, the image data for authentication produced from the checking object image is compared with the image data for authentication read out from the database 12.

Further, consistency is calculated between the image data for authentication produced from the checking object image and the image data for authentication read out from the database 12. If the consistency is equal to a predetermined value or more, the checking object image is judged there is no falsification after photographing at step 240 like the first embodiment.

Likewise, the second embodiment can be effectively applied to a case where a counterfeit image is on purpose regarded as an image photographed by the camera which has been authenticated, so that falsification of the photographic image can effectively be prevented.

A third embodiment of the present invention will be hereinafter described.

Namely, in the third embodiment, identification information is embedded into image data of a photographed image on the camera side, and an authentication section authenticates an image by using the identification information.

An embodiment of a system for implementing the method for this embodiment is schematically shown in FIG. 7.

In FIG. 7, an authentication section 50 functions to authenticate a status that a photographed image is photographed by a camera 60 registered in the authentication section SO and a status that the image is directed to an authentic image which was not falsified after being photographed. The camera 60 such as a digital still camera is registered in the authentication section 50 in advance. When photographing a subject 70, the camera 60 communicates with the authentication section 50, incorporates watermark information (authentication data) sent from the authentication section 50 into the photographed imager and then stores the photographed image having the watermark information embedded therein in a storage medium 80 such as a smart media.

Further, the authentication section 50 has a database 52 for recording information necessary for authenticating the photographed image, such as photographed image (data) identification information and image characteristic amount, which are sent from the camera 60.

An example of the photographing method employed using the camera according to this embodiment is shown in the flow chart of FIG. 8, and an authentication method thereof is shown in the flow chart of FIG. 9. An example of image authentication method of this embodiment will be described along with these flow charts.

First, the photographing method employed using the camera will be described along with the flow chart shown in FIG. 8. At step 300, the camera 60 is beforehand registered in the authentication institution 50, similarly to the first embodiment.

Next, when photographing by the camera 60, at step 310, the authentication section 50 confirms/authenticates a status that the camera to be used for photographing is the one that is registered in the authentication section 50. Therefore, the camera 60 sends a data registration request signal, including a camera TO and the like, to the authentication section 50. Upon receiving the encrypted data registration request signal from the camera 60, the authentication section 50 decrypts the signal to confirm a status that the camera 60 has been already registered.

At step 320, the authentication section 50 generates watermark information (authentication data) unique to a photographed image file, and sends it back to the camera 60. Further, the authentication section 50 stores the watermark information with at least one of the camera ID, an image file name, a photographer ID, and a reception date and time, etc. in the database 52.

At step 330, the camera 60 photographs a subject 70. Then, at step 340, the camera 60 decrypts the watermark information sent back from the authentication section 50 and incorporates the watermark information into the photographed image.

This incorporation method is not particularly limited and any well known embedding algorithm can be adopted. However, the employed embedding algorithm should be desirably confidential. Alternatively, a plurality of algorithms may be prepared. The algorithms may be randomly selected in the camera 60, or the algorithms may be switched corresponding to a selection signal included in the sent back information from the authentication section 50. Then, in the authentication section 50, information concerning which algorithm is employed, is also recorded in the database 52. In additions identification data of the watermark information may be added as header information of the photographed image in the camera 60.

Next, at step 350, the camera 60 stores the photographed image data using the watermark information embedded in a storage medium 80.

The photographing process using the camera 60 is carried out as above-mentioned. A recipient of the storage medium 80, in which the photographed image is stored as above-mentioned, sends the stored image data to the authentication section 50 using a predetermined communication unit and requests authentication of validity of the image.

The authentication process will be described along with the flow chart shown in FIG. 9.

When the recipient of the photographed image requests falsification check of the image to the authentication section 50, first at step 400, the image data is transmitted to the authentication section 50.

At step 410, the authentication section 50, which has received the image data, reads out from the database 52 the watermark information of the image data corresponding to the image to be checked recorded in the database according to the image file name of the image data and watermark information identification data of the header.

Further, the authentication section 50 extracts the watermark information from the image to be checked in step 420. Next, at step 430, the authentication section 50 then compares the watermark information extracted from the image to be checked and the watermark information read out from the database 52. If a degree of consistency is equal to a predetermined value or greater as a result of the comparison, the authentication section 50 judges at step 440 a status that there is no falsification in the checked image.

As above-mentioned, according to this embodiment, since the watermark information is embedded in the image data, it becomes impossible to change only the image data without altering the watermark information. Therefore, it is possible to cope with the case where the image is counterfeited by manipulating the photographed image and to effectively prevent falsification of the photographed image.

Furthermore, as another example, there is a method in which multipoint distance measuring data of a camera and image data characteristic amount, are transmitted to an authentication section as a set and recorded in a database when photographing using the camera. Then, authentication process is implemented by using this data. According to this method, e.g. when counterfeit image data is made by photographing a counterfeit image print, a subject of the counterfeit image can be found two-dimensional one for its distance measuring data. If an authentic image scene is three-dimensional, the counterfeit image data contradicts it. Therefore, it is possible to judge the presence of falsification based on the contradictions between the distance measuring data and the image data upon authenticating.

As above-mentioned in detail, according to each embodiment of the present invention, it is possible to check falsification and counterfeit of the image for cases such as pretending that a counterfeit image is an image photographed using an authenticated camera and intending to deceive the authentication section by manipulating the photographed image.

Further, instead of image data of the photographed image as they stand, only the image characteristic amount, compressed image data, or thinned-out image data or the like may be registered. Thereby, data capacity of the authentication section may be reduced. Thus it becomes possible to achieve judgment of the image falsification and effective prevention of the image falsification.

In the foregoing, the methods of preventing falsification of an image have been described in detail. Note that, however, the present invention is not limited to the above-described examples, and it is a matter of course that various modifications and alterations can be made within the scope of the present invention without departing from the gist of the same.

According to the present invention as above-mentioned, it is possible to judge presence of the falsification of a photographed image and to prevent the falsification of the image. Then the present invention can be carried out without requiring a storage medium having a specific function for cases such as pretending that a counterfeit image is an image photographed using an authenticated camera and intending to deceive the authentication section by manipulating the photographed image.

What is claimed is:

1. A method of preventing falsification of an image of a produced image produced in an imaging apparatus, comprising the steps of:
extracting a first image characteristic amount by a specified algorithm from said produced image in said imaging apparatus;
recording identification information of said produced image in said imaging apparatus and said first image characteristic amount into a database of an authentication section which authenticates a status that there is no falsification in said produced image;
regarding as an authentication object image whose authentication is requested to said authentication section, extracting a second image characteristic amount by said specified algorithm from said authentication object image;
comparing said first image characteristic amount with said second image characteristic amount, in which said extracted authentication data and said authentication data recorded in said database have the same identification information,; and
judging whether or not said authentication object image is falsified after said image production, based on consistency between said first and second image characteristic amounts acquired from said comparison in order to prevent said falsification of said produced image based on said judgment.

2. The method according to claim 1, wherein said imaging apparatus has a camera, in which said produced image is a photographic image photographed by said camera, in which said identification information is an identification information or said camera or a file name of said photographic image or an identification information a photographer of said photographic image.

3. The method according to claim 1, wherein said imaging apparatus has a computer in which said produced image is a computer graphics image produced by said computer or an image which has been image-processed by said computer, and said identification information is an identification information of said computer or a file name of said produced image, or an identification information of a producer of said produced image.

4. A method of preventing falsification of a produced image produced in an imaging apparatus, comprising the steps of:
producing an image to acquire a first image data of the produced image in said imaging apparatus,
recording identification information for identifying said produced image by said imaging apparatus and said first image data of said produced image by said imaging apparatus into a database in an authentication section which authenticates that there is no falsification in said produced image,
comparing a second image data of authentication object image which has been requested to be authenticated by said authentication section, with said first image data recorded in said databases in the said authentication section, in which said extracted authentication data and said authentication data recorded in said database have the same identification information, and
judging whether or not said authentication object image is falsified after said image production, based on consistency between said first and second image characteristic amounts acquired from said comparison in order to prevent said falsification of said produced image based on said judgment.

5. The method according to claim 4, wherein said imaging apparatus has a camera, in which said produced image is a photographic image photographed by said camera, and said identification information is an identification information of said camera or a file name of said photographic image or an identification information of a photographer of said photographic image.

6. The method according to claim 4, wherein said imaging apparatus has a computer, in which said produced image is a computer graphics image produced by said computer or an image which has been image-processed by said computer, and information of said computer or a file name of said produced image or an identification information of a producer of said produced image.

7. A method of preventing falsification of a produced image produced in an imaging apparatus, comprising the steps of:
sending authentication data from an authentication section for authenticating a status that there is no falsification in a produced image which is produced by said imaging apparatus to said imaging apparatus,
recording said authentication data and identification information for identifying said produced image of said imaging apparatus into a database in said authentication section,
attaching said authentication data to said produced image or embedding said authentication data into said produced image, when said imaging apparatus produces said produced image,
extracting said authentication data from an authentication object image which has been requested to be authenticated in said authentication section,
comparing said extracted authentication data with said authentication data recorded in said database, in which said extracted authentication data and said authentication data recorded in said database have the same identification information, and
judging whether or not said authentication object image is falsified after said image production, based on consistency between said extracted authentication data and said authentication data acquired from said comparison in order to prevent said falsification of said produced image based on said judgment.

8. The method according to claim 7, wherein said imaging apparatus has a camera, in which said produced image is a photographic image photographed by said camera, and said identification information is an identification information of said camera or a file name of said photographic image or an identification information of a photographer of said photographic image.

9. The method according to claim 7, wherein said imaging apparatus has a computer, in which said produced image is a computer graphics image produced by said computer or an image which has been image-processed by said computer, and said identification information is an identification information of said computer or a file name of said produced image or an identification information of producer of said produced image.
